(19) United States
(12) Patent Application Publication
(10) Pub. No.: US 2019/0094132 A1
(43) Pub. Date: Mar. 28, 2019

(54) OPTICAL MEASUREMENT PROBE AND OPTICAL MEASUREMENT DEVICE PROVIDED WITH SAME

(71) Applicants: Shimadzu Corporation, Kyoto (JP); HONDA MOTOR CO., LTD., Tokyo (JP)

(72) Inventors: Ryoji HIRAOKA, Kyoto (JP); Mitsuru KOWADA, Saitama (JP); Isao AZUMAGAKITO, Saitama (JP); Hirofumi FUJIWARA, Saitama (JP)

(73) Assignees: Shimadzu Corporation, Kyoto (JP); HONDA MOTOR CO., LTD., Tokyo (JP)

(21) Appl. No.: 16/085,127

(22) PCT Filed: Mar. 31, 2016
(86) PCT No.: PCT/JP2016/060753

§ 371 Date: Sep. 14, 2018

(51) Int. Cl. G01N 21/25; G01N 21/27

(52) U.S. Cl. CPC G01N 21/255; G01N 2201/0636; G01N 21/27

(57) ABSTRACT

An optical measurement probe is a probe for guiding light generated from a measurement target to an appliance, and includes an optical window and an optical fiber. The optical window is formed in a columnar shape, one of end surfaces of which forms a reflection surface (tapered surface), the optical window transmitting light entering from an incident surface (flat surface) formed on a portion of an outer peripheral surface of the optical window, causing the light to be reflected by the reflection surface, and emitting the light from the other end surface. The optical fiber guides the light emitted from the other end surface of the optical window to the appliance.

### TECHNICAL FIELD

The present invention relates to an optical measurement probe for guiding light generated from a measurement target to an appliance, and an optical measurement device provided with the same.

### BACKGROUND ART

In an optical measurement device for measuring light generated from a measurement target, an optical probe may be used for guiding light from a measurement target to an appliance. An optical probe of this type includes a transparent optical window and a light guide made of optical fiber, and light entering the optical window is guided to the appliance through the light guide (see PATENT DOCUMENT 1, for example).

In the optical probe of this type, the optical window is formed in a columnar shape, for example, and light entering from one end surface of the optical window is transmitted through the optical window to be guided from the other end surface to the light guide. In other words, light entering straight along an axial direction of the optical window is guided to the light guide through the optical window.

### CITATION LIST

### Patent Document

PATENT DOCUMENT 1: Japanese Unexamined Patent Publication No. 2015-43278

### SUMMARY OF THE INVENTION

### Technical Problem

In the conventional optical probe described above, only light entering from within a predetermined field-of-view range with respect to the axis of the optical window is guided to the light guide. Thus, if the installation position of the optical probe is limited, there are cases in which light from a desired direction cannot be guided to the light guide.

In view of this, the inventors of the present invention have thought of an optical probe that allows light to enter an optical window from its outer peripheral surface, and can guide the light entering the optical window to a light guide by reflecting the light at an end surface of the optical window. However, in this optical probe, the outer peripheral surface of the optical window that is curved in an arc shape serves as a light incident surface, and thus this incident surface acts like a lens (cylindrical lens). The outer peripheral surface of the optical window has a radius of curvature of about 0.8 millimeter, for example, which is relatively small, and the curvature accordingly increases. Consequently, the field-of-view range thereof becomes wider. Depending on the installation position of the optical probe, it may be required in some cases that the field-of-view range is limited and only light entering from within a certain narrow field-of-view range is measured.

The present invention has been made in view of the above circumstances, and aims to provide an optical measurement probe that can effectively limit a field-of-view range of light entering from an outer peripheral surface of an optical window, and an optical measurement device provided with the same.

### Solution to the Problem

An optical measurement probe according to the present invention is an optical measurement probe for guiding light generated from a measurement target to an appliance, and includes an optical window and a light guide. The optical window is formed in a columnar shape, one of end surfaces of which serves as a reflection surface, the optical window transmitting light entering from an incident surface formed on a portion of an outer peripheral surface of the optical window, causing the light to be reflected by the reflection surface, and emitting the light from the other end surface. The light guide guides the light emitted from the other end surface of the optical window to the appliance. The incident surface is formed by a flat surface.

In this configuration, a flat surface formed on a portion of the outer peripheral surface of the optical window can be used as an incident surface, and light can enter the optical window from this incident surface, be reflected by the reflection surface formed by the one end surface of the optical window, and be emitted from the other end surface. Since the incident surface is formed by the flat surface, the incident surface is not allowed to act like a lens, and the field-of-view range does not become wider. Thus, the field-of-view range of light entering from the outer peripheral surface of the optical window can be effectively limited.

The incident surface may extend parallel to an axial direction of the optical window.

In this configuration, light enters the optical window from the incident surface that extends parallel to the axial direction of the optical window. In this case, the incident surface can be formed through simply cutting a portion of the outer peripheral surface of the optical window in a direction parallel to the axial direction.

The incident surface may be inclined with respect to the axial direction of the optical window.

In this configuration, light enters the optical window from the incident surface that is inclined with respect to the axial direction of the optical window. In this case, the incident surface can be formed through simply cutting a portion of the outer peripheral surface of the optical window along a direction that is inclined with respect to the axial direction. The incident surface inclined with respect to the axial direction of the optical window can limit the field-of-view range of light entering from the outer peripheral surface of the optical window more effectively than the incident surface extending along the axial direction of the optical window.

The optical measurement probe may further include a reflection coating formed on the reflection surface.

In this configuration, use of properties of the reflection coating formed on the reflection surface allows the light to be reflected in a desired manner, and enter the light guide.

The reflection coating may be a dielectric multilayer.

In this configuration, use of the property, of the dielectric multilayer formed on the reflection surface, of being able to provide any reflectivity allows the light having a desired wavelength to be reflected with high efficiency, and enter the light guide.

Alternatively, the reflection coating may be a metal film.

In this configuration, use of properties of the metal film formed on the reflection surface allows the light to be reflected in a manner according to the type of the metal, and enter the light guide.

The optical measurement probe may further include a main body holding the optical window and the light guide. In this case, the optical window may be attached to an end portion of the main body with the incident surface and the reflection surface protruding outward.

In this configuration, light entering the incident surface protruding outward from the end portion of the main body can be reflected by the reflection surface and guided to the light guide, and additionally, other light can be blocked by the main body from being guided to the light guide. Thus, only the light entering from the incident surface can be suitably guided to the light guide.

An optical measurement device according to the present invention includes the optical measurement probe and a detector detecting light guided by the optical measurement probe.

In the optical measurement device according to the present invention, the optical measurement probe is attached to a cylinder head of an internal combustion engine to face an inside of a combustion chamber that is a measurement target.

The cylinder head may have a valve-train-driving-member accommodation chamber for accommodating a valve-train driving member. In this case, the optical measurement probe may be provided on a side opposite to the valve-train-driving-member accommodation chamber in the cylinder head.

### Advantages of the Invention

According to the present invention, the incident surface is formed by a flat surface. Thus, the incident surface is not allowed to act like a lens, and the field-of-view range does not become wider. Consequently, the field-of-view range of light entering from the outer peripheral surface of the optical window can be effectively limited.

### BRIEF DESCRIPTION OF THE DRAWINGS

FIG. 1 is a diagram illustrating an exemplary configuration of an optical measurement device provided with an optical measurement probe according to one embodiment of the present invention.

FIG. 2 is a side view illustrating how light enters an optical window.

FIG. 3 is a front view illustrating how light enters the optical window.

FIG. 4 is a graph illustrating results of a heat-resistance evaluation test for a dielectric multilayer.

FIG. 5A is a diagram illustrating where the optical measurement probe is attached in a cylinder head, and FIG. 5B is a cross-sectional view taken along line A-A in FIG. 5A.

FIG. 6 is a side view illustrating a modification of the optical measurement probe.

### DESCRIPTION OF EMBODIMENTS

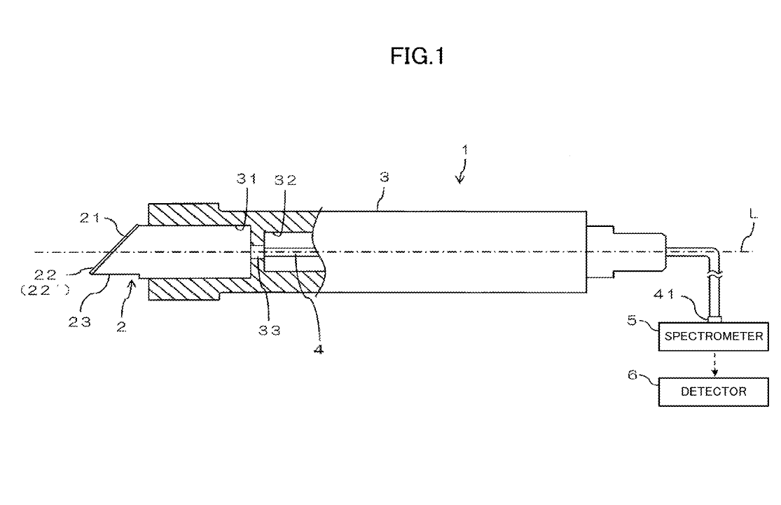

FIG. 1 is a diagram illustrating an exemplary configuration of an optical measurement device provided with an optical measurement probe 1 according to one embodiment of the present invention. FIG. 1 illustrates, partially in section, a specific configuration of the optical measurement probe 1.

The optical measurement probe 1 according to the present embodiment guides light that is generated from a measurement target during combustion to an appliance. The optical measurement probe is installed in a combustion chamber of an internal combustion engine of a car or a motorcycle, for example, and is used to evaluate a combustion state in the combustion chamber. The optical measurement probe 1 includes an optical window 2, a main body 3, and an optical fiber 4. In FIG. 1, only a distal end portion of the main body 3 of the optical measurement probe 1 is illustrated in section.

The optical window 2 is made of quartz or sapphire, for example, and allows light entering from outside to pass through the optical window 2 to be taken into the main body 3. The main body 3 is made of metal such as stainless steel. The optical window 2 and the optical fiber 4 are integrally held by the main body 3, and light transmitted through the optical window 2 enters one end portion of the optical fiber 4 along the direction of an axis L.

The main body 3 is formed in a cylindrical shape, for example, and the optical window 2 is accommodated in one of end portions thereof. Specifically, in the one end portion of the main body 3, a recess having an inner diameter corresponding to the outer diameter of the optical window 2 is formed, and this recess serves as an optical-window accommodation section 31 for accommodating the optical window 2. In the main body 3, a recess extending from the other end portion forms an optical-fiber accommodation section 32 for accommodating the optical fiber 4. The optical-window accommodation section 31 and the optical-fiber accommodation section 32 communicate with each other through a communicating hole 33, and light transmitted through the optical window 2 enters the optical fiber 4 in the optical-fiber accommodation section 32 through the communicating hole 33.

The optical measurement device according to the present embodiment includes a spectrometer 5 and a detector 6 in addition to the optical measurement probe 1 described above. The spectrometer 5 is disposed on the other end portion of the optical fiber 4. To the other end portion of the optical fiber 4, a connector 41 is attached, and this connector 41 is connected to the spectrometer 5. Light received by the optical measurement probe 1 enters the spectrometer 5 from the other end portion of the optical fiber 4, and light dispersed by the spectrometer 5 is detected by the detector 6.

In this example, the optical window 2 is formed in a columnar shape, and on an end portion thereof through which light enters, a tapered surface 21 is formed. Specifically, the optical window 2 extends along the axis L just like the optical fiber 4, and an end surface thereof opposite to the optical fiber 4 in the direction of the axis L is the tapered surface 21. The tapered surface 21 is preferably inclined at an angle of 30° to 60° with respect to the axis L, and is inclined at an angle of about 45° in this example.

On the tapered surface 21, for example, a dielectric multilayer 22 is formed. The dielectric multilayer 22 is formed with a plurality films having different refractive indices. These films are sequentially vapor-deposited on the tapered surface 21 to provide, integrally with the optical window 2, the dielectric multilayer 22 in which films having appropriate thicknesses are stacked.

The dielectric multilayer 22 may have a structure in which low-refractive-index films made of material having a low refractive index and high-refractive-index films made of material having a high refractive index are alternately stacked. In this case, the low-refractive-index films may be SiO₂ films, and the high-refractive-index films may be Ta₂O₅ films, for example. Such a dielectric multilayer 22 can be formed by using a known method such as ion plating.

This type of dielectric multilayer 22 has a property of reflecting light having a predetermined wavelength with high efficiency. The dielectric multilayer 22 is not limited to have the structure described above, and may be made of other materials such as HfO₂, Al₂O₃, MgF₂, TiO₂, and ZrO₂. Alternatively, the dielectric multilayer 22 may be formed of a stack of three or more thin optical films.

In this case, the dielectric multilayer 22 is preferably designed and formed in consideration of influences exerted on the reflectivity by materials (e.g., soot and oil) that might adhere to the dielectric multilayer 22 under environments in which the optical measurement probe 1 is used.

On an outer peripheral surface of the optical window 2 toward the tapered surface 21, a flat surface 23 extending parallel to the direction of the axis L is formed. The flat surface 23 is formed to at least partially overlap with the tapered surface 21 when viewed in a direction orthogonal to the axis L, for example. In this example, the flat surface 23 is a stepped portion that is formed to extend from an end surface of the optical window 2, which is the tapered surface 21, in a direction parallel to the axis L. However, the flat surface 23 is not limited to this configuration, and may be formed of a recess that is formed on the outer peripheral surface of the optical window 2, for example.

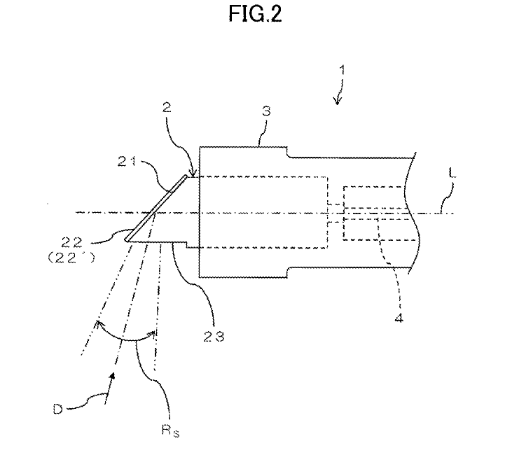

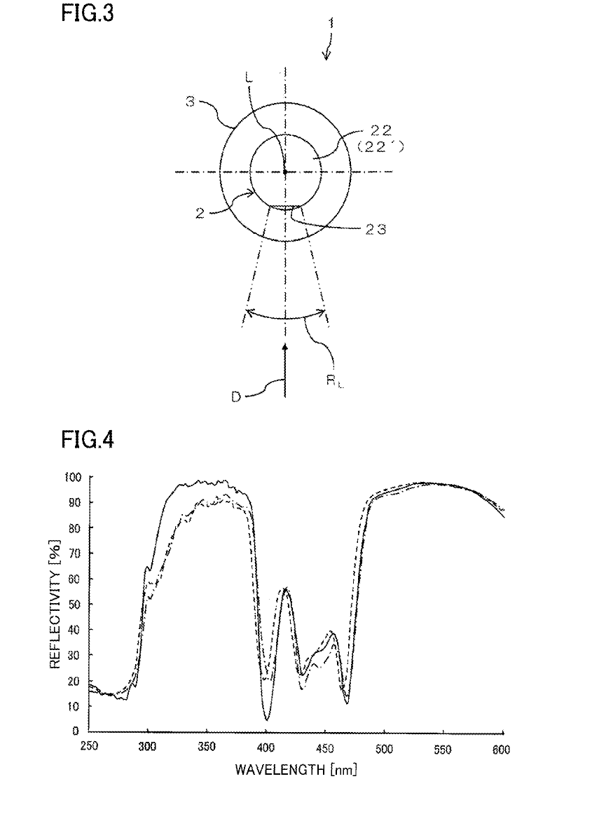

FIGS. 2 and 3 illustrate, in a side view and a front view, how light enters the optical window 2.

In a state in which the optical window 2 is attached to the end portion of the main body 3, the tapered surface 21 and the flat surface 23 protrude outward from the main body 3. A portion of the optical window 2 accommodated in the optical-window accommodation section 31 of the main body 3 is provided with no flat surface 23, and still has a cylindrical shape with a curved outer peripheral surface. With this shape, stability and durability can be ensured when the optical window 21 is sealed with respect to the main body 3.

In the present embodiment, the flat surface 23 of the optical window 2 serves as a light incident surface. Thus, light entering the flat surface 23 from a direction D intersecting with the direction of the axis L passes through the optical window 2, is reflected by the tapered surface 21, and is emitted from an end surface of the optical window 2 opposite to the tapered surface 21 to be guided to the optical fiber 4.

In other words, the tapered surface 21 of the optical window 2 is a reflection surface that reflects light entering from the direction D different from the direction of the axis L, and causes the light to enter the optical fiber 4 along the axis L. The dielectric multilayer 22 serves as a reflection coating formed on the reflection surface (tapered surface 21).

Of the light entering through the flat surface 23 of the optical window 2, only light within predetermined field-of-view ranges R_{S} and R_{L} centered around the direction D enters the optical fiber 4, and other light can be blocked by the main body 3 from entering the optical fiber 4. Thus, only light from the predetermined direction D can be suitably caused to enter the optical fiber 4. The field-of-view ranges R_{S} and R_{L} depend on the numerical aperture (NA) of the optical fiber 4 and the shape of the optical window 2.

In the present embodiment, the flat surface 23 formed on a portion of the outer peripheral surface of the optical window 2 can be used as an incident surface. Thus, light can enter the optical window 2 from this flat surface 23, be reflected by the tapered surface 21 formed on one of the end surfaces of the optical window 2, and be emitted from the other end surface. Since the incident surface is formed by the flat surface 23, the incident surface is not allowed to act like a lens, and the field-of-view range R_{L} does not become wider. Thus, the field-of-view range R_{L} of light entering from the outer peripheral surface of the optical window 2 can be effectively limited.

Specifically, the field-of-view range R_{S} has an angle range of about 23° when viewed from the direction of FIG. 2 (direction orthogonal to the direction of the axis L), and the field-of-view range R_{L} has an angle range of about 23° when viewed from the direction of FIG. 3 (the direction of the axis L) is about 23°. Forming the incident surface by the flat surface 23 makes it possible to effectively limit the field-of-view range R_{L} when viewed from the direction of FIG. 3 in particular, and thus, the angle ranges of the field-of-view ranges R_{S} and R_{L}, which are originally about 60° with the outer peripheral surface of the optical window being still curved in an arc shape, can be limited to an angle range of about 23° as described above.

In the present embodiment, light enters the optical window 2 from the flat surface 23 extending parallel to the direction of the axis L of the optical window 2. In this case, the flat surface 23 can be formed through simply cutting a portion of the outer peripheral surface of the optical window 2 in a direction parallel to the direction of the axis L.

Particularly, in the present embodiment, the dielectric multilayer 22 is formed on the tapered surface 21. Thus, use of the property of the dielectric multilayer 22 allows the light having a desired wavelength to be reflected with high efficiency, and enter the optical fiber 4.

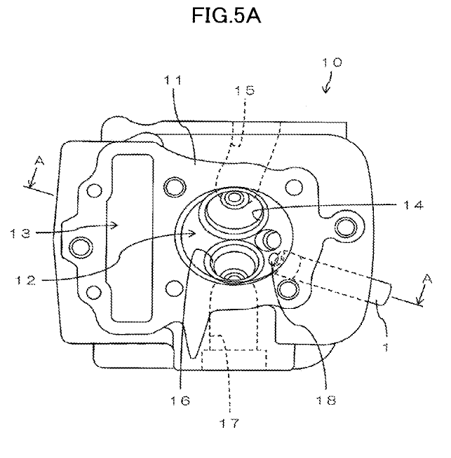

FIG. 4 is a graph illustrating results of a heat-resistance evaluation test for the dielectric multilayer 22. In this test, the dielectric multilayer 22 having a high reflectivity at a predetermined wavelength was used, and heat resistance was evaluated by comparing, with the initial reflectivity (solid curve in FIG. 4), the reflectivity of the dielectric multilayer heated by a burner for 40 minutes (dashed-dotted curve in FIG. 4) and the reflectivity of the dielectric multilayer heated in a thermostatic oven at 850° C. for three hours (broken curve in FIG. 4).

It can be seen from the results in FIG. 4 that the reflectivity of the dielectric multilayer 22 does not easily decrease even if the dielectric multilayer is exposed to high-temperature conditions for a long time. Thus, even in a high-temperature environment, such as a situation where light generated during combustion is measured by the optical measurement probe 1, only light having a predetermined wavelength can be suitably reflected by the dielectric multilayer 22 and guided to the optical fiber 4.

In the above embodiment, it has been described that the dielectric multilayer 22 is formed on the tapered surface 21 of the optical window 2. However, this is not limiting, and for example, a metal film 22′ may be formed on the tapered surface 21 of the optical window 2. In this case, use of properties of the metal film 22′ formed on the tapered surface 21 allows the light to be reflected in a manner depending on the type of the metal, and enter the optical fiber 4. In a preferred embodiment, the metal film 22′ is made of metal having a melting point of 1000° C. or higher.

For example, when the metal film 22′ is made of aluminum, a reflection coating that is inexpensive and has high reflectivity can be obtained. When the metal film 22′ is made of gold, a reflection coating that can suitably reflect light having an infrared wavelength can be obtained. When the metal film 22′ is made of rhodium or ruthenium, a reflection coating having a very high melting point and high heat resistance can be obtained.

As described above, use of properties of the reflection coating formed on the tapered surface 21 allows the light to be reflected in a desired manner, and enter the optical fiber 4. The reflection coating is not limited to the dielectric multilayer 22 or the metal film 22′, and may be made of any material that matches required properties.

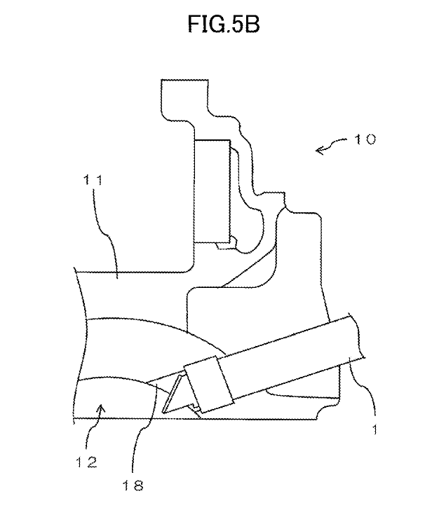

FIG. 5A is a diagram illustrating where the optical measurement probe 1 is attached in a cylinder head 11. FIG. 5B is a cross-sectional view taken along line A-A in FIG. 5A. For example, a combustion chamber 12 surrounded by the cylinder head 11, and a cylinder block and a piston (not depicted) is formed in an internal combustion engine 10 of a car, a motorcycle, or the like.

The optical measurement probe 1 is attached to the cylinder head 11 to face the inside of the combustion chamber 12 that is a measurement target, for example. Specifically, in the cylinder head 11, a valve-train-driving-member accommodation chamber 13 for accommodating a valve-train driving member (e.g., a cam chain, not shown) is formed, and the optical measurement probe 1 is disposed on the side opposite to the valve-train-driving-member accommodation chamber 13 across the center of the cylinder.

In the cylinder head 11, an intake port 15 communicating with an intake valve opening 14 that is open toward the combustion chamber 12, and an exhaust port 17 communicating with an exhaust valve opening 16 that is open toward the combustion chamber 12 are formed. In this example, near the intake valve opening 14 and the exhaust valve opening 16 of the cylinder head 11, a probe insertion opening 18 which is open toward the combustion chamber 12 is formed.

The probe insertion opening 18 is provided at a position across the intake valve opening 14 and the exhaust valve opening 16 from the valve-train-driving-member accommodation chamber 13, for example. When a combustion state in the combustion chamber 12 of the internal combustion engine 10 is evaluated, for example, light generated in the combustion chamber 12 can be guided to the optical measurement probe 1 through the probe insertion opening 18.

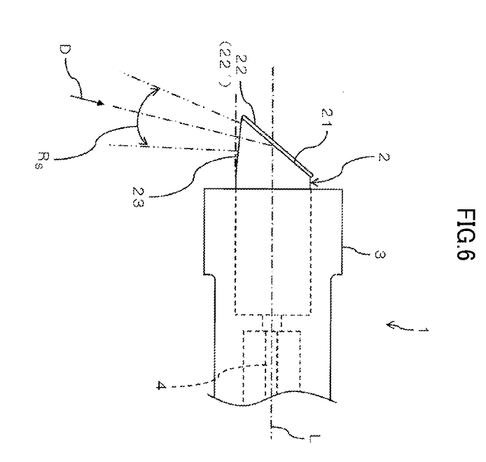

FIG. 6 is a side view illustrating a modification of the optical measurement probe 1. In the above embodiment, it has been described that the flat surface 23 forming the incident surface of the optical window 2 extends parallel to the direction of the axis L. In contrast, in an example in FIG. 6, the flat surface 23 is inclined with respect to the axis L. The inclination angle of the flat surface 23 with respect to the axis L is preferably 1° to 20°, more preferably 3° to 10°. Since the elements of this modification are the same as those of the above embodiment except for this inclination, like elements are designated by like reference characters in the drawings, and detailed description thereof is omitted.

Also in this example, the flat surface 23 is formed to at least partially overlap with the tapered surface 21 when viewed in the direction orthogonal to the axis L, for example. In this example, the flat surface 23 can be formed through simply cutting a portion of the outer peripheral surface of the optical window 2, from the end surface of the optical window 2, which is the tapered surface 21, along a direction inclined with respect to the axis L.

The flat surface 23 inclined with respect to the axis L of the optical window 2 can limit the field-of-view range R_{S} of light entering from the outer peripheral surface of the optical window 2 more effectively than the flat surface 23 of the above embodiment extending along the axis L of the optical window 2. Specifically, the angle range of the field-of-view range R_{S} when viewed from the direction of FIG. 6 (direction orthogonal to the axis L) is about 17°, and the angle range of the field-of-view range R_{L} when viewed from the axis L orthogonal to the direction of FIG. 6 is about 11°.

In the above embodiment, it has been described that the reflection coating is formed on the tapered surface 21 of the optical window 2 forming the reflection surface. However, the structure with the reflection coating is not limiting as long as the light can be reflected by the tapered surface 21 and can enter the optical fiber 4.

The optical fiber 4 is not limited to guide the light to the spectrometer 5, and may guide light to another appliance. The light guide for guiding light to an appliance is not limited to the optical fiber 4, and may guide light by using another member.

Note that the optical measurement probe 1 according to the present invention is not limited to the one installed in a combustion chamber of an internal combustion engine of a car, a motorcycle, or the like, and can be installed in any high-temperature environment to guide light that is generated at the time of combustion to an appliance.

### DESCRIPTION OF REFERENCE CHARACTERS

1 Optical Measurement Probe
2 Optical Window
3 Main Body
4 Optical Fiber
5 Spectrometer
6 Detector
10 Internal Combustion Engine
11 Cylinder Head
12 Combustion Chamber
13 Valve-Train-Driving-Member Accommodation Chamber
14 Intake Valve Opening
15 Intake Port
16 Exhaust Valve Opening
17 Exhaust Port
18 Probe Insertion Opening
21 Tapered Surface
22 Dielectric Multilayer
22′ Metal Film
23 Flat Surface
31 Optical-Window Accommodation Section
32 Optical-Fiber Accommodation Section
33 Communicating Hole
41 Connector

1-10. (canceled)

11. An optical measurement probe for guiding light generated from a measurement target to an appliance, the optical measurement probe comprising:
an optical window formed in a columnar shape, one of end surfaces of which serves as a reflection surface, the optical window transmitting light entering from an incident surface formed on a portion of an outer peripheral surface of the optical window, causing the light to be reflected by the reflection surface, and emitting the light from the other end surface; and
a light guide configured which guides the light emitted from the other end surface of the optical window to the appliance, wherein the incident surface is formed by a flat surface.

12. The optical measurement probe of claim 11, wherein the incident surface extends parallel to an axial direction of the optical window.

13. The optical measurement probe of claim 11, wherein the incident surface is inclined with respect to an axial direction of the optical window.

14. The optical measurement probe of claim 11, further comprising a reflection coating formed on the reflection surface.

15. The optical measurement probe of claim 14, wherein the reflection coating is a dielectric multilayer.

16. The optical measurement probe of claim 14, wherein the reflection coating is a metal film.

17. The optical measurement probe of claim 11, further comprising a main body holding the optical window and the light guide, wherein the optical window is attached to an end portion of the main body with the incident surface and the reflection surface protruding outward.

18. An optical measurement device comprising:
the optical measurement probe of claim 11; and
a detector detecting light guided by the optical measurement probe.

19. The optical measurement device of claim 18, wherein the optical measurement probe is attached to a cylinder head of an internal combustion engine to face an inside of a combustion chamber that is a measurement target.

20. The optical measurement device of claim 19, wherein the cylinder head has a valve-train-driving-member accommodation chamber for accommodating a valve-train driving member, and
the optical measurement probe is provided on a side opposite to the valve-train-driving-member accommodation chamber in the cylinder head.
